(19) United States
(12) Patent Application Publication
(10) Pub. No.: US 2024/0086024 A1
(43) Pub. Date: Mar. 14, 2024

(54) CREATION AND DEPLOYMENT OF DIGITAL ACTIVITY

(71) Applicant: Lucid Software, Inc., South Jordan, UT (US)

(72) Inventors: Cole T. Rosenberg, South Jordan, UT (US); Saurabh Sudhir Phadnis, Salt Lake City, UT (US); Pinen Chen, Draper, UT (US); Jarom Yan-Ming Chung, South Jordan, UT (US); William Weilian Wang, Draper, UT (US); Lucas Alexander Barnes, Taylorsville, UT (US)

(21) Appl. No.: 17/932,237

(22) Filed: Sep. 14, 2022

(51) Int. Cl. G06F 3/0481; G06F 3/04847

(52) U.S. Cl. CPC G06F 3/0481; G06F 3/04847

(57) ABSTRACT

A method of creating a digital activity may include selecting an interactive digital design element to be added to the digital activity, the interactive digital design element configured to allow multiple users to interact with the interactive digital design element when deploying the digital activity. The method may include generating a data structure, the data structure representative of a repository into which data representative of user inputs are stored when interacting with the interactive digital design element when deployed. The method may include deploying the interactive digital design element in a visual space shared between the multiple users.

### FIELD

The embodiments discussed herein are related to the creation and/or deployment of a digital activity.

### BACKGROUND

Digital tools can help teams or groups of people communicate with their members. Surveys are helpful methods of monitoring member metrics, such as well-being or productivity.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a method of creating a digital activity may include selecting an interactive digital design element to be added to the digital activity, the interactive digital design element configured to allow multiple users to interact with the interactive digital design element when deploying the digital activity. The method may include generating a data structure, the data structure representative of a repository into which data representative of user inputs are stored when interacting with the interactive digital design element when deployed. The method may include deploying the interactive digital design element in a visual space shared between the multiple users.

In an example embodiment, a non-transitory computer-readable medium may include computer-readable instructions stored thereon that are executable by a processor to perform or control performance of operations. The operations may include selecting an interactive digital design element to be added to the digital activity, the interactive digital design element configured to allow multiple users to interact with the interactive digital design element when deploying the digital activity. The operations may include generating a data structure, the data structure representative of a repository into which data representative of user inputs are stored when interacting with the interactive digital design element when deployed. The operations may include deploying the interactive digital design element in a visual space shared between the multiple users.

Additional features and advantages of the present disclosure will be set forth in the description which follows, and in part will be obvious from the description, or may be learned by the practice of the present disclosure. The features and advantages of the present disclosure may be realized and obtained by means of the instruments and combinations particularly pointed out in the appended claims. These and other features of the present disclosure will become more fully apparent from the following description and appended claims, or may be learned by the practice of the present disclosure as set forth hereinafter.

### BRIEF DESCRIPTION OF THE DRAWINGS

To further clarify the above and other advantages and features of the present disclosure, a more particular description of the present disclosure will be rendered by reference to specific embodiments thereof which are illustrated in the appended drawings. It is appreciated that these drawings depict only typical embodiments of the present disclosure and are therefore not to be considered limiting of its scope. The present disclosure will be described and explained with additional specificity and detail through the use of the accompanying drawings in which:

FIG. 1 is a visual representation of a system for the creation of and/or use of a digital activity;

FIG. 2 is a flowchart of an example method of creating and/or deploying a digital activity in a shared visual space;

FIG. 3 is an example of a graphical user interface (GUI) via which a user may select an interactive digital design element to be used in a digital activity;

FIG. 4 is another example of a GUI via which a user may create a digital activity;

FIGS. 5A and 5B illustrate an example of progression from construction of a digital activity in a GUI to deployment of the digital activity in a shared visual space;

FIG. 6 is a flowchart illustrating an example method of creating a digital activity that may include one or more interactive digital design elements;

FIG. 7 is another example of a GUI via which a digital activity may be built;

FIG. 8 is a flowchart illustrating an example method of handling the reception of input data from a user during a digital activity;

FIG. 9 is a flowchart illustrating an example method of processing input data from multiple users received during a digital activity;

FIG. 10 illustrates an example of a digital activity and a visual representation of stored user input data associated with the digital activity;

FIG. 11 is an example digital display of data related to user inputs from multiple users across multiple interactions with an example digital activity over time;

FIG. 12 is another example digital display of inputs from multiple users across multiple user interactions with a digital activity over time;

FIG. 13 is an example graphical user interface through which a creator of an activity may utilize a template to generate the activity; and

FIG. 14 illustrates an example of a computing system;

all in accordance with one or more embodiments of the present disclosure.

### DETAILED DESCRIPTION

Some forms of communication may be inefficient and ineffective at gleaning the desired information from participants. Some existing technologies may be too rigid in design or narrow in scope to be fully beneficial to their users. In circumstances where users, especially teams, have specific communication needs or desires, it may be helpful to utilize digital tools with enough flexibility for users to create the information-gathering tools they need. With the ability to create their own digital activity, teams may design surveys or other information-gathering or information-sharing activities to precisely fit their need, and do so in a way that may be creative and engaging for participants.

Some embodiments herein may allow for complete user creativity in the creation of a digital activity by permitting a user to select one or more interactive digital design elements which may each be customized by the addition of one or more attributes. In some embodiments, users may be able to configure a digital activity with significant detail. For example, a user may be able to define the relationships between interactive digital design elements, including determining whether data should be transferred between interactive digital design elements and how the data may be transformed when transferring from one interactive digital design element to another. Additionally, data generated from user interaction with a digital activity may be stored, analyzed, and shared within or outside of the digital activity, including via other electronic devices or communication technologies. Further, participation in a digital activity may take place among multiple users simultaneously as well as asynchronously.

In some circumstances, embodiments of the present disclosure may facilitate improvement in the performance of a computer by applying the teachings of the present disclosure. For example, by providing for the creation and storage of a digital activity in a remote computing system, network traffic to and from and the computational load associated with a general computing device can be transitioned to a more robust computing device like a cloud-computing system. As another example, the digitization and capture of ideation may be improved to permit simultaneous and flexible interaction with a digital interface to facilitate the capture and processing of information gathering.

Reference will now be made to the drawings to describe various aspects of example embodiments of the present disclosure. It is to be understood that the drawings are diagrammatic and schematic representations of such example embodiments, and are not limiting of the present disclosure, nor are they necessarily drawn to scale.

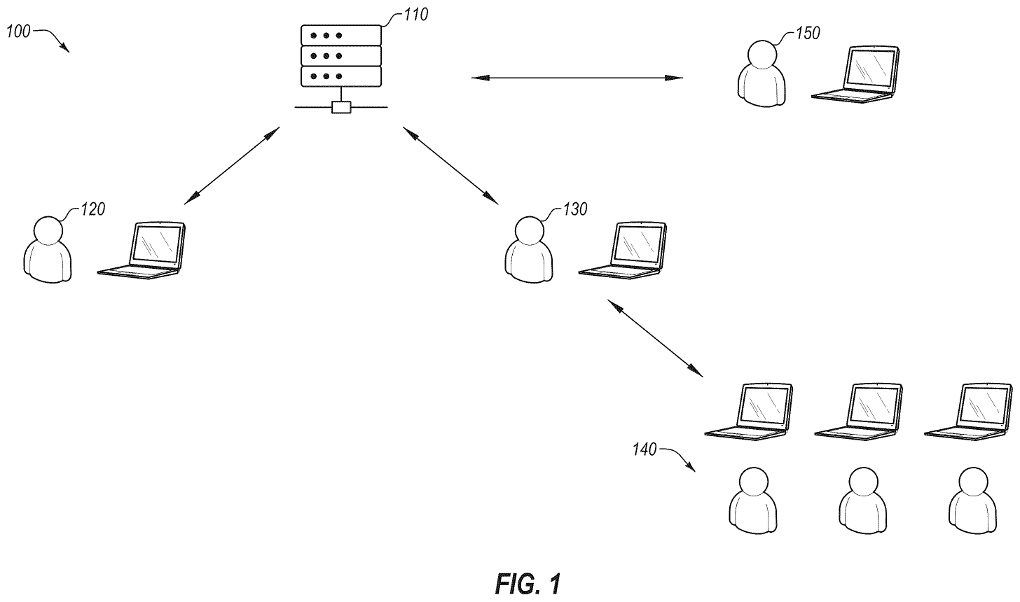

FIG. 1 illustrates an environment 100 within which a digital activity may be created and/or implemented. A digital activity may include a question or task, or a series of questions and/or tasks, designed in a digital space and made for the participation of users in order to achieve some goal, such as information gathering, entertainment, facilitating alignment of team members with each other and/or with a company's or manager's objective(s) or goal(s), building consensus between and among team members, and/or team-building. The environment 100 may include a server 110 that may facilitate the creation, storage, and/or deployment of a digital activity; a user 120 that may create a digital activity; a user 130 who may facilitate deployment of the digital activity to themselves and/or other users 140; and/or a user 150 that may perform and/or request post-processing on data associated with the deployment of and/or interactions with a digital activity.

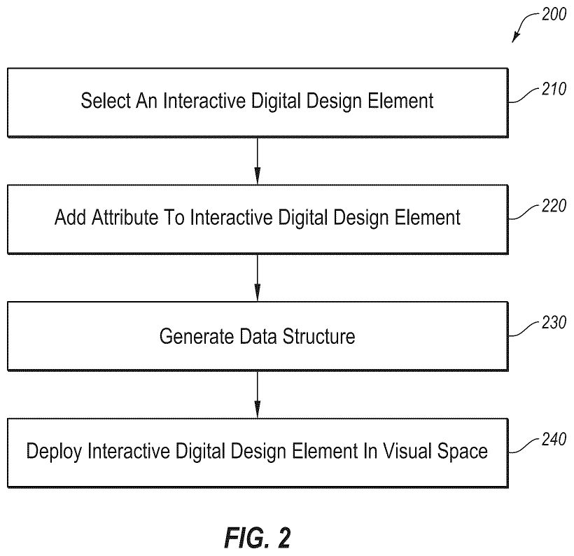

In some embodiments, the user 120 may utilize an electronic device to create a digital activity in a computer-readable medium, which may then be stored in the server 110. In some embodiments, the user 120 may create the digital activity by incorporating one or more interactive digital design elements, customized by the addition of one or more attributes, into an activity space that can be shared to users in a visual space when deploying the digital activity. Some examples of the creation of a digital activity may be described with reference to FIGS. 2, 3, 4, 6, and 7.

In some embodiments, the user 130 may utilize an electronic device to deploy the digital activity (such as by retrieving, requesting execution of, and/or streaming the digital activity from the server 110). Deployment of the digital activity may include sharing the digital activity to the one or more targeted users 140 via one or more electronic methods, such as email, messaging applications, video conferencing applications, or office management applications. Additionally or alternatively, the deployment may include computational execution via the server 110 and the user 130 and/or the users 140 may interact with the deployed digital activity remotely via their own respective electronic devices while the digital activity is executed or otherwise deployed at the server 110. In some embodiments, the deployment may include the digital activity being transmitted to and executed locally by the user 130 and/or the users 140. In some embodiments, the user 120 and the user 130 may be the same user.

In some embodiments, when participating in the digital activity, any type of electronic device may be used. For example, the electronic device may include a laptop or desktop computer, a mobile telephone, a tablet, or any other electronic device. In some embodiments, the interface and/or visual display of the digital activity may be tailored to the type of electronic device used by the user 130 and/or the users 140 when participating in the digital activity. For example, interacting with the interactive digital design elements may be optimized for a touch display or a mouse for the user input. As another example, the resolution and orientation of the visual space may be varied based on the electronic device used by the user 130 and/or the users 140.

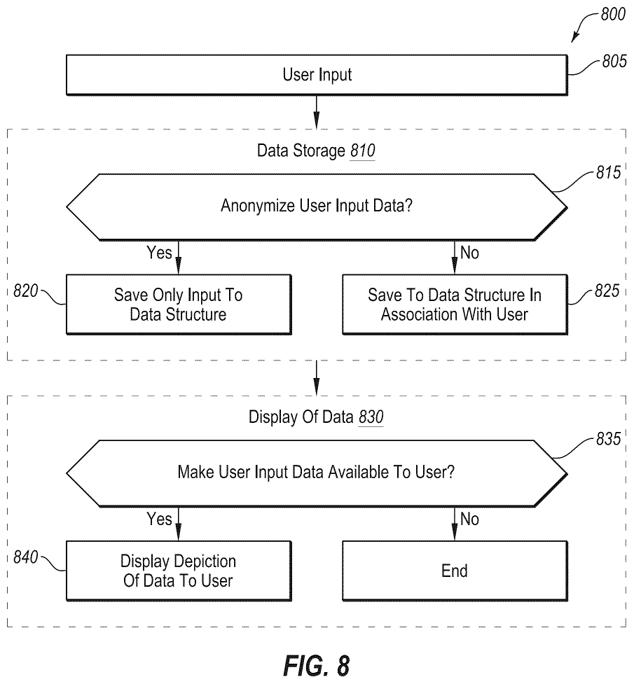

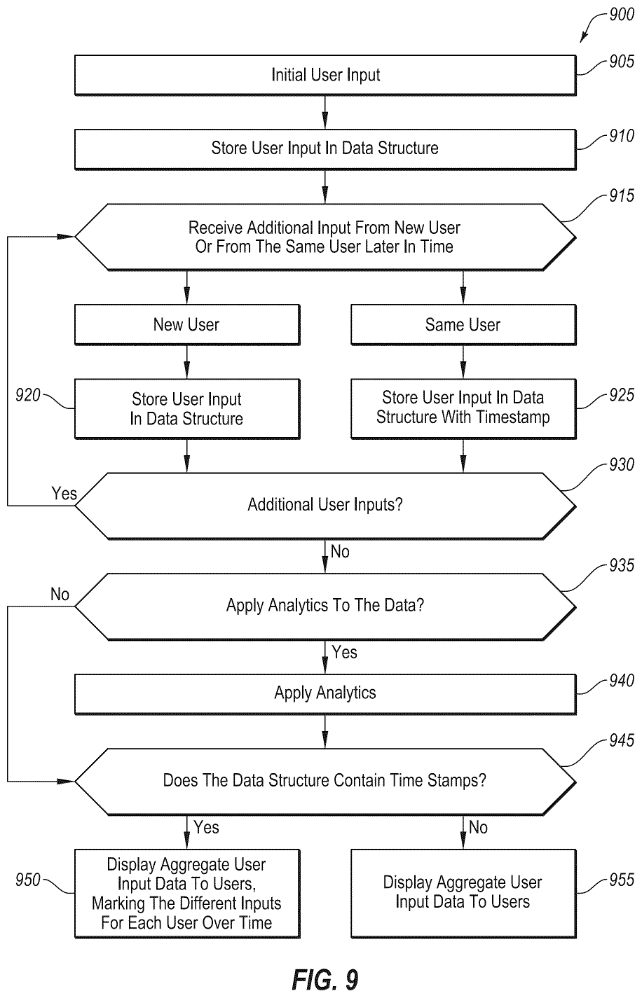

When granted access to the deployed digital activity, the one or more users 140 and/or the user 130 may then participate in the digital activity. Participation may include completing one or more of the task(s) and/or answering one or more of the question(s) set out by the digital activity in the manner prescribed by the activity. For example, one question may include having a user spatially rank one or more options along an x and y axis, or one task may include having a user draw a picture with their cursor to participate. The data related to the user inputs as they participate may be stored in the server 110 and/or stored locally by the electronic device of the user participating in the digital activity. Examples of participation may be explained with reference to FIGS. 8 and 9.

After one or more users (such as the users 130 and/or the user 140) have participated in the digital activity, another user 150 may access the data related to the user inputs stored in the server 110. In some embodiments, the user 150 may perform post-processing on the data and/or generate visualizations of the data which can be stored in the server 110. The post-processing and/or visualization generation may include generating graphs or charts of the collected data, processing the data by applying statistical analyses, formulas or other calculations, and/or analyzing the data by comparing the inputs from different participating users. In some embodiments, the post-processing and/or visualization generation may include the user 150 requesting the server 110 to undertake one or more of the operations associated with the post-processing and/or visualization generation. Examples of the post-processing and/or visualization generation may be described with reference to FIGS. 8-12.

Modifications, additions, or omissions may be made to the environment 100 without departing from the scope of the present disclosure. For example, the designations of different elements in the manner described is meant to help explain concepts described herein and is not limiting. For instance, in some embodiments, any particular user may fulfill multiple roles, such as the same user being the user 120 that generates the activity, and the user 130 that deploys the activity, and the user 150 that performs post-processing and/or visualization generation based on participation in the deployed activity. Further, the environment 100 may include any number of other elements or may be implemented within other systems or contexts than those described.

FIG. 2 is a flowchart of an example method 200 of creating and/or deploying a digital activity in a shared visual space, in accordance with one or more embodiments of the present disclosure. The method 200 may be performed by any suitable system, apparatus, or device. For example, the method 200 may be performed by an electronic device of the user 120, the user 130, the users 140, and/or the user 150, and/or the server 110.

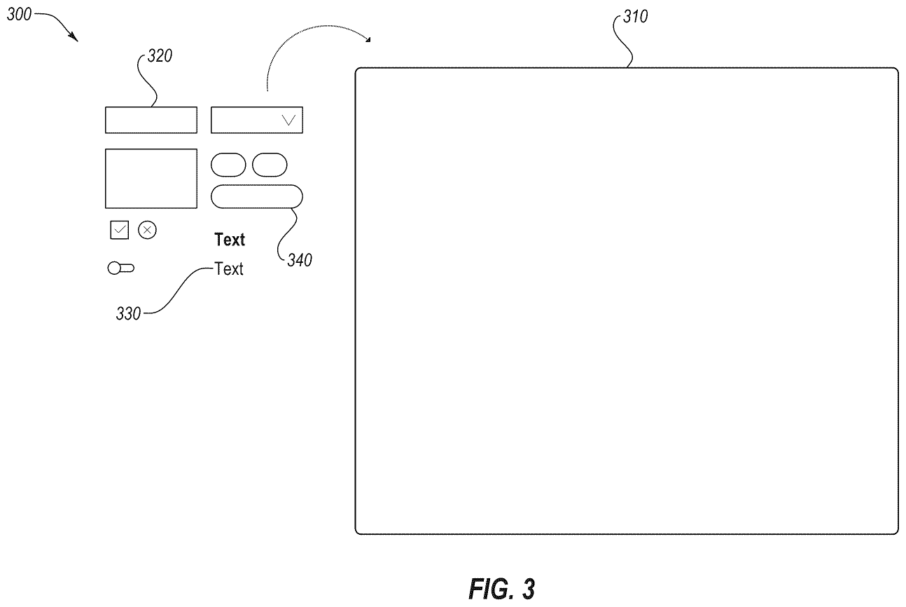

At block 210, an interactive digital design element may be selected. For example, a user may select an interactive digital design element from within a graphical user interface (GUI). An example of such a GUI is illustrated in FIG. 3, among others. An interactive digital design element may include any visual element such as a line, shape, text, or other feature that may be used to build out a digital activity. Additionally or alternatively, an interactive digital design element may include or contain an image, meme, graphic interchange format (GIF), animated GIF, video, or other graphical object with which a user may interact.

At block 220, an attribute may be added to the interactive digital design element. For example, the user may add color, labeling, or other formatting to the interactive digital design element selected at the block 210. Other examples of attributes include the designation of lines as a plot, a line as a slider, a shape as a container to hold other interactive digital design elements, a shape as selectable by the user when deployed, a shape as moveable by the user when deployed, and a shape or area as a space to receive freeform user input. In some embodiments, multiple attributes may be added to a single interactive digital design element.

At block 230, a data structure may be generated that corresponds to the interactive digital design element. For example, the selection of the interactive digital design element at block 210 and the addition of the attribute at the block 220 may result in the generation of a data structure that is reflective of the data related to the of the user. For example, if a selected interactive digital design element and its attribute form a two-dimensional plot, then the data structure generated may include space to hold x- and y-coordinates such that when a user participating in the deployed digital activity selects a point on the plot, the choice of the user can be saved in the data structure. As another example, the data structure may store information related to binary user inputs, such as the selection or non-selection of an option or button, user categorization of interactive digital design elements, user-designated relationships between interactive digital design elements, and/or freeform user inputs, such as may be created by a user using a cursor when participating in the digital activity.

At block 240, the interactive digital design element may be deployed in a visual space. For example, the interactive digital design elements may be part of a digital activity that may be stored for later deployment, and the block 240 may reflect the deployment of the interactive digital design element in the digital activity such that a user (which may be a different user than the one that selects the interactive digital design element at the block 210) may interact with the digital activity. In some embodiments, the visual space may be shared between multiple users, and where users with access to the visual space may participate in the deployed activity within the same shared visual space.

In some embodiments, the block 210, 220, and/or 230 may be repeated until the user working to generate the digital activity is satisfied and is ready to store the digital activity for future deployment of the digital activity in a visual space, such as may occur at the block 240. In this way, a digital activity may be built with multiple interactive digital design elements.

FIG. 3 is an example of a graphical user interface (GUI) 300 via which a user may select an interactive digital design element to be used in a digital activity. The interactive digital design element may include, for example, a shape 320, text 330, or another feature. After being selected, the interactive digital design element may be placed within the activity space 310. In some embodiments, the activity space 310 may be a designated area within the GUI 300 where the user creating the digital activity may assemble the digital activity or a part of the digital activity.

In some embodiments, after an interactive digital design element has been placed in the activity space 310, one or more attributes 340 may be added to the interactive digital design element. For example, a menu may be invoked for the interactive digital design element (e.g., by right-clicking on the shape 320) and one or more options may be selected to designate an attribute for the interactive digital design element. Such an attribute may include a color, a size, a weight, a shape, a level of opacity, a type of element (e.g., an axis, a plot, a slider, a multi-selection radio button, a drop-down menu, a container, among others), and/or a user ability (e.g. an ability to move or drag an element, an ability to create a freeform input via a cursor), among others.

In some embodiments, a user may designate a region of the activity space 310 as being associated with a given attribute such that as interactive digital design elements are dropped into the designated region, the interactive digital design element may automatically have the given attribute applied to the interactive digital design element.

In some embodiments, interactive digital design elements and their attribute(s) may be selected simultaneously. For example, the GUI 300 may include interactive digital design elements that may include attributes already applied to the interactive digital design elements (e.g., a plot with colored axes, a set of radio button options with multiple elements built in, among others) that may be selected to be included in the activity space 310.

In some embodiments, the GUI 300 may not include a designated activity space 310 in which to arrange interactive digital design elements and/or their attribute(s). For example, some embodiments may allow a user to select one or more interactive digital design elements and/or their attribute(s) but may not display the resulting digital activity or part of a digital activity until completion of creation of the digital activity.

One example of generating the digital activity may include a categorization activity. A user may add one or more interactive digital design elements, such as a shape, to the activity space, then apply an attribute that makes the shape(s) a container. Different containers may be designated as different categories by adding text, color, graphics, or other differentiating interactive digital design elements or attributes. Additional interactive digital design elements, like shapes, text, or graphics, may then be added to the activity space and given attributes that enable them to be selected and moved by a user participating in the digital activity and placed in any of the designated containers. The containers may be configured with attributes to limit the number of interactive digital design elements that may be placed within each container.

Another example of generating the digital activity may include a voting/multiple option activity. A user may add two or more interactive digital design elements, such as shapes, text, or graphics (including images, memes, videos, or GIFs), to an activity space and add an attribute to each element to make the interactive digital design elements selectable by a participating user. The activity may be configured to allow users to select only one element at a time or the activity may be configured to allow all elements to be selected at one time and to generate a ranking for each consecutive element selected.

An additional example of generating the digital activity may include a scale/rating activity. A user may input an interactive digital design element such as a line into the activity space and apply an attribute to designate the line as an axis. Endpoints and/or intervals may be added along the axis using text, shapes, or other interactive digital design elements and/or attributes to represent options and/or a scale. An additional shape or other interactive digital design element with an attribute to designate the element as a slider may be added to the axis. A slider may be selected by a user participating in the activity and dragged along the axis upon which the slider sits to indicate user choice. In some embodiments, the axis may contain discrete or continuous options. Additionally or alternatively, multiple axes may be combined, such as in a spiderplot.

An additional example of generating the digital activity may include a plotting activity. A user may select one or more interactive digital design elements, such as a line, to be placed in the activity space. An attribute may be added to each line to designate the line as an axis. Endpoints and/or intervals may be added along any or all of the axes using text, shapes, or other interactive digital design elements and/or attributes. One or more additional interactive digital design elements may be added to the activity space with attributes added to make the elements selectable and moveable by a participating user. The selectable and moveable elements may be placed by a participating user anywhere around or on the axes to represent user choice.

An additional example of generating the digital activity may include a clustering and/or arranging activity. A user may input one or more interactive digital design elements, such as text, shapes, or graphics, into the activity space and apply attributes that make them selectable and moveable by users participating in the activity. These elements may then be arranged by participating users or clustered to represent user thinking. In some embodiments, the selectable and moveable interactive digital design elements may be input into the activity space or otherwise chosen by the participating user during the digital activity rather than being pre-chosen by the user creating the digital activity.

An additional example of generating the digital activity may include a freeform response activity. A user may create a prompt by inserting one or more interactive digital design elements, such as text, shapes, or graphics, into the activity space. A user may designate which tools will be available to participating users when they create their response to the prompt. Tools may include virtual pens, highlighters, colored markers, and/or insertable graphics. A participating user may respond via the virtual tools in any way in the activity space during the activity.

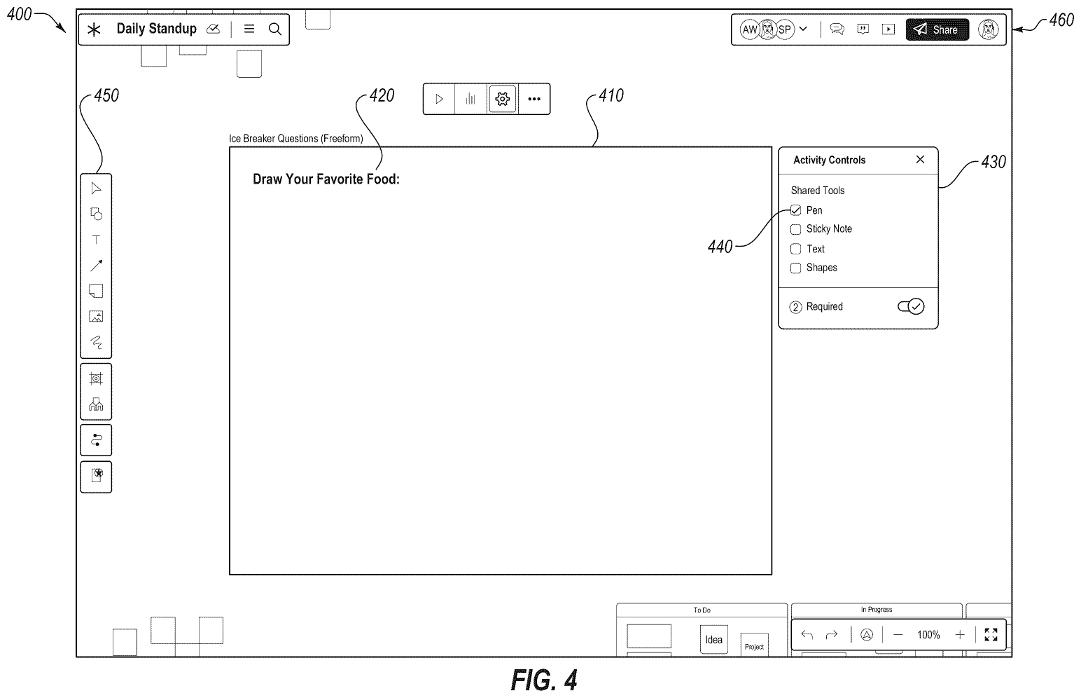

FIG. 4 is another embodiment of a GUI 400 via which a user may create a digital activity, in accordance with one or more embodiments of the present disclosure. As illustrated in FIG. 4, an interactive digital design element is already deployed in an activity space 410, namely, text 420 in the form of a question. In some embodiments, the activity space 410 may be accompanied by an options panel 430 that displays several attributes 440. The attributes may affect how a user may be able to interact with the digital activity when deployed. For example, attributes may include a virtual writing instrument with which a user may create a freeform input, text, shapes, graphics and/or other methods by which a user may create an input. Additionally or alternatively, the options panel 430 may contain other attributes such as color, labeling, and/or other formatting.

In some embodiments, the options panel 430 may designate which of multiple input modalities are permitted when the digital activity. For example, the user creating the digital activity may select that a virtual pen is usable when the digital activity is deployed, while a sticky note, text, or shape deploying tools are not usable when the digital activity is deployed.

In some embodiments, the options panel 430 may include a second option 450 via which the user may designate that a certain aspect of the digital activity and/or the entire digital activity is a “required” digital activity. For example, when deployed, a user interacting with the digital activity may be required to provide a response to the designated portion of the digital activity before proceeding on to a next digital activity.

In some embodiments, the GUI 400 may include a panel 450 of options that may be used in creating the digital activity. For example, the panel may include options for placing an icon, a shape, text, a line, a virtual sticky note, an image, or any other electronic display element. Additionally or alternatively, relationships between interactive digital design elements may be adjusted or implemented using the panel of options.

In some embodiments, the GUI 400 may include an administrative panel 460 via which one or more users may be permitted to independently or cooperatively work on the creation of the digital activity. The administrative panel may additionally or alternatively allow the placement of comments, observing how the digital activity will appear when deployed, permit the observation of which users are currently viewing and/or editing the digital activity. Additionally or alternatively, the administrative panel may permit the sharing of the digital activity to one or more other users for editing and/or deployment of the digital activity.

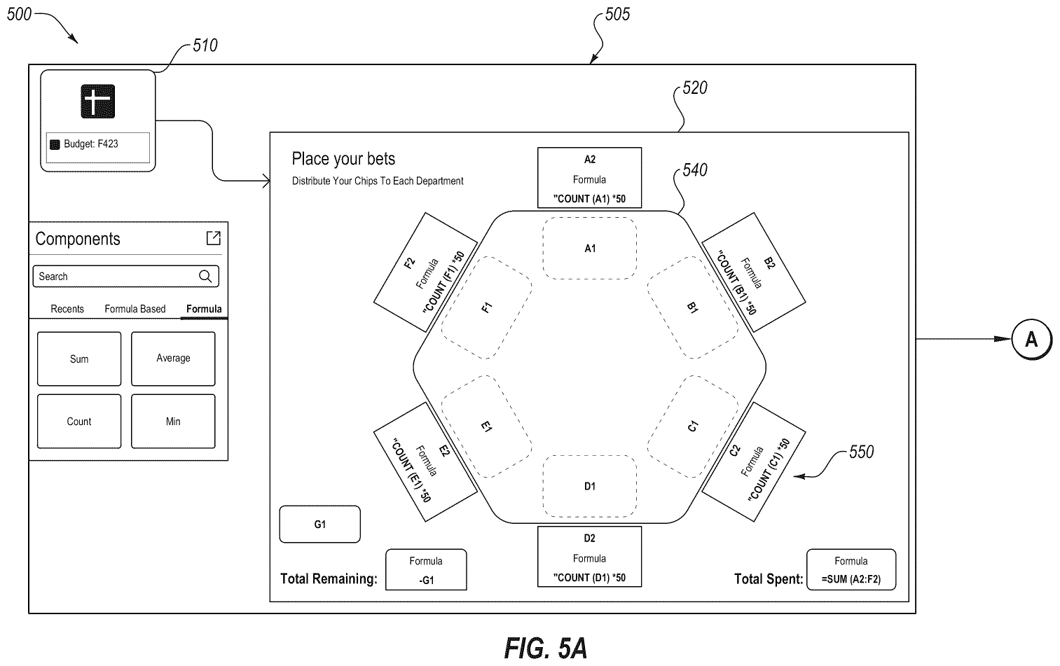

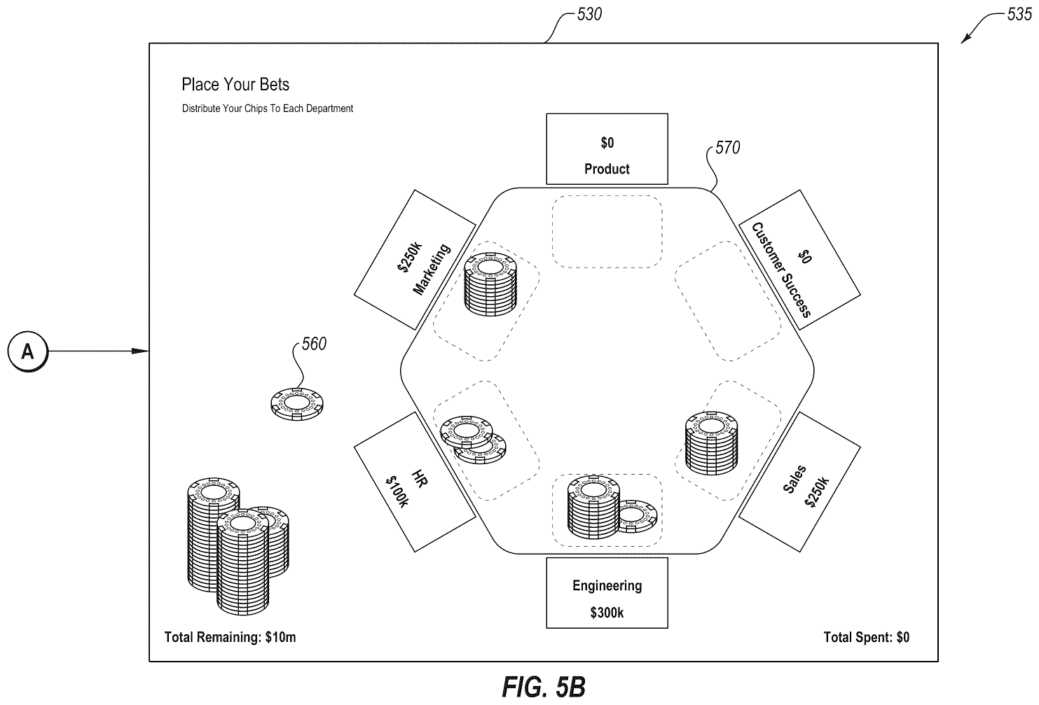

FIGS. 5A and 5B are an example visualization 500 of the progression from the creation of a digital activity 505 in a graphical user interface 520 to the deployment of the digital activity 535 in a visual space 530. For example, the example visualization 500 includes a digital activity that relies on external or underlying data that is incorporated into the digital activity. In this example, a hexagon shape 540 is surrounded on each side and underneath by text boxes 550 housing formulas. The formulas in the text boxes 550 may be imported into the activity from an electronic spreadsheet 510 or other electronic source, including sources that may be saved to a server. In other embodiments, information imported into a digital activity may include financial information, employee identification information, calendar data, and/or other data helpful to the management of employees or teams which may be imported into the digital activity 505 from an external source such as an external spreadsheet, database, resource or relationship management program, or any other external source.

In some embodiments, the formulas may be manually entered and/or modified by the user when creating the digital activity 505. In some embodiments, a formula or formula-based set of attributes or interactive digital design elements may be included when creating a digital activity such that a user may click and drag or otherwise apply a formula to a given interactive digital design element. For example, the user may select the count formula to a first interactive digital design element and it may apply the formula to the data held in another interactive digital design element. Additionally or alternatively, the formula may be applied to a data cell (such as in an external spreadsheet) or other data element in an external file.

In the deployed activity 535, graphical tokens 560 may be moved around by a participating user and placed on any of the six sides of the deployed hexagon shape 570. The formulas imported into the digital activity generate a dollar amount for each side of the deployed hexagon shape 570 based on the number of graphical tokens 560 placed on each side by a user. Additionally or alternatively, calculations may take place after a user has participated in a digital activity rather than during participation. In these and other embodiments, one or more users may simultaneously participate in the digital activity 535 to move around various tokens to facilitate the visual distribution of a budget. In some embodiments, the underlying data in the external file may be updated based on the result of the digital activity 535 when deployed. For example, the information in the corresponding data cells of an external spreadsheet may be updated based on the various users' participation in the deployed digital activity 535.

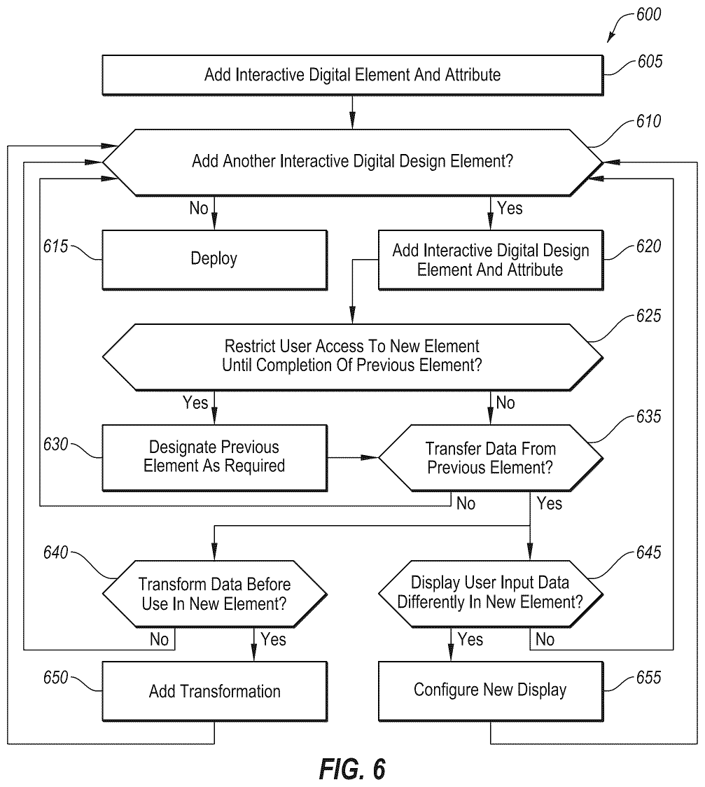

FIG. 6 is a flowchart illustrating an example method 600 of creating a digital activity that may include one or more interactive digital design elements. The method 600 may be performed by any suitable system, apparatus, or device. For example, the method 600 may be performed by an electronic device of the user 120, the user 130, the users 140, and/or the user 150, and/or the server 110. Although illustrated with discrete blocks, the steps and operations associated with one or more of the blocks of the method 600 may be divided into additional blocks, combined into fewer blocks, or eliminated, depending on the particular implementation.

At block 605, an interactive digital design element and/or accompanying attribute(s) may be added to a visual space. For example, the user may select one or more elements from a GUI to be placed at specific locations within the visual space. In some embodiments, multiple interactive digital design elements with associated attributes may be simultaneously selected via the selection of a template or other larger building block of interactive digital design elements from which the digital activity may be created.

At block 610, a determination may be made whether there are additional interactive digital design element(s) to be added. If there are no further interactive digital design element(s) to be added, the method 600 may proceed to block 615. If there are additional interactive digital design element(s) to be added, the method 600 may proceed to block 620.

At block 615, the digital activity may be deployed and/or stored for future deployment. For example, the digital activity may be provided to one or more additional users for participation in the digital activity. As another example, the digital activity may be placed in long-term or short-term storage, such as on a server.

At block 620, another interactive digital design element and/or an accompanying attribute(s) may be added to the digital activity. The block 620 may be similar or comparable to the block 605.

At block 625, a determination may be made whether access to the newly added interactive digital design element for users who participate in the digital activity is to be restricted until such users have completed the previous interactive digital design element. If such a restriction is to be included, the method 600 may proceed to the block 630, If such a restriction is not to be included, the method 600 may proceed to block 635.

At block 630, the previous interactive digital design element may be designated as required. For example, the user may set an attribute marking the element as required such that a relationship exists between two successive interactive digital design elements and/or two successive digital activities. The relationship may prevent the user from progressing beyond the required interactive digital design element in the digital activity before participating therein when deployed.

At block 635, a determination may be made whether to transfer user input data from the previous interactive digital design element to the newly added interactive digital design element. For example, the newly added interactive digital design element may build off of, perform mathematical calculations, aggregate, or otherwise act on the data representative of the user input(s) with the previous interactive digital design element. If a determination is made not to transfer user input data between the previous interactive digital design element and the newly added interactive digital design element, the method 600 may return to the block 610 to potentially add additional interactive digital design elements. If the determination is made to transfer data from the previous interactive digital design element to the newly added interactive digital design element, the method 600 may proceed to blocks 640 and/or 645.

Blocks 640 and 645 may be completed one before the other or simultaneously as order does not matter. Additionally or alternatively, only one of blocks 640 and/or 645 may be performed.

At block 640, a determination may be made whether to transform the data from the previous interactive digital design element before the data is shared to the newly added interactive digital design element. For example, transformation of the user input data may include the application of one or more formulas, reordering, transposing, formatting, combining with other information, and/or deidentifying of the user information. For example, any identifiers associated with the user input data may be removed such that the user input data may be utilized in the newly added interactive digital design element in an anonymous way. If the user input data is to be transformed, the method 600 may proceed to the block 650. If no transformation is to be performed, the method 600 may return to the block 610.

At block 645, a determination may be made whether to display the user input data in a different manner in the newly added interactive digital design element than in the previous interactive digital design element. If it is determined that the user input data is to be displayed differently, the method 600 may proceed to the block 655. If it is determined that the user input data is not to be displayed differently, the method 600 may return to the block 610.

At block 655, the display of the user input data may be configured in the different manner. For example, if the initial user input data includes selection of a point along a slider, the display of the user input data may be displayed in a table with numerical values of user input from multiple users rather than visually displaying the slider with the location of the selections of the users. After the block 655, the method 600 may return to the block 610 to determine if additional interactive digital design elements are to be added. Additional interactive digital design elements may be added until the user creating the digital activity is ready to store or deploy the digital activity.

Modifications, additions, or omissions may be made to the method 600 without departing from the scope of the disclosure. For example, another method of creating a digital activity may not include the option of whether or not to transfer data from one interactive digital design element to the next, or it may limit the number of interactive digital design elements that may be added to the digital activity. As an additional example, the designations of different operations in the manner described is meant to help explain concepts described herein and is not limiting. Further, the method 600 may include any number of other operations or may be implemented within other systems or contexts than those described.

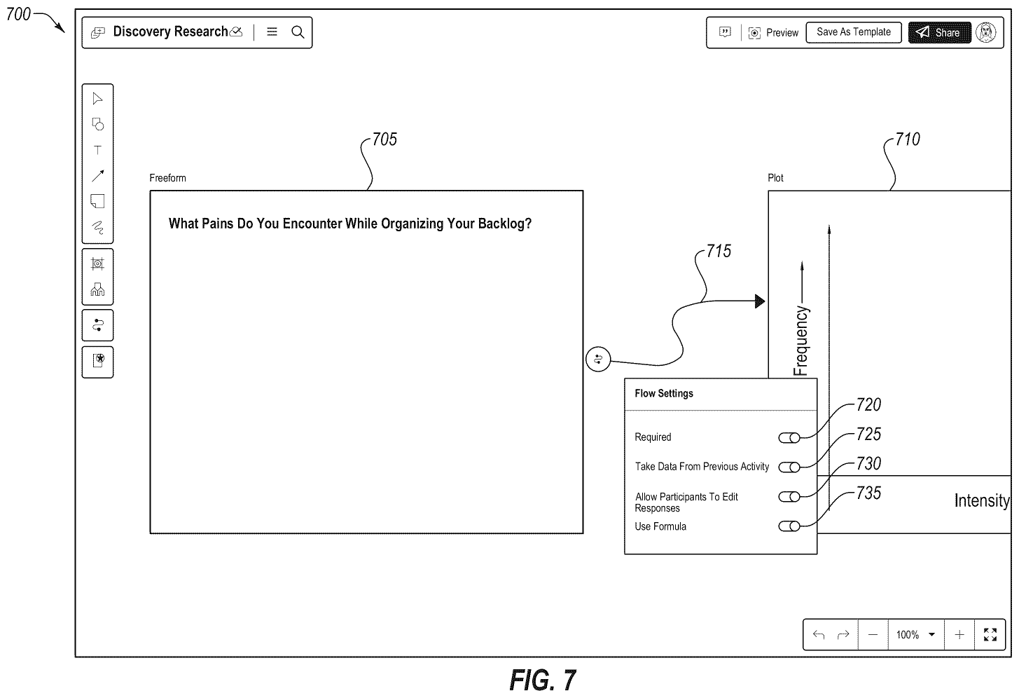

FIG. 7 is another example of a GUI 700 via which a digital activity may be built. In some embodiments, during the creation of a digital activity, an interactive digital design element 705 may be placed alongside a succeeding interactive digital design element 710. A relationship 715 between successive interactive digital design elements may be visually apparent. The relationship 715 may include configurable settings that describe and inform the operation of the digital activity when transitioning between the two successive interactive digital design elements 705 and 710.

In some embodiments, the settings associated with the relationship 715 between the successive interactive digital design elements 705 and 710 may be configured. For example, the settings may include a requirement 720 that users complete the preceding interactive digital design element 705 before proceeding to the interactive digital design element 710 when participating in the digital activity. As another example, the settings of the relationship 715 may include a setting 725 that data from the interactive digital design element 705 is to be carried over to the succeeding interactive digital design element 710. As an additional example, the settings of the relationship 715 may include a setting 730 that allows participants edit their responses. As another example, the settings of the relationship 715 may include a setting 735 that indicates a formula is to be used on the data as it is carried over from the interactive digital design element 705 to the succeeding interactive digital design element 710.

In some embodiments, the interactive digital design element 705 and the succeeding interactive digital design element 710 may differ in type and/or attribute(s). For example, the interactive digital design element 705 may include a question with space for a freeform user input while the succeeding interactive digital design element 710 may include a two-dimensional plot upon which users participating in the digital activity may select locations.

Using the example, of FIG. 7, the first interactive digital design element 705 may ask users to input via freeform the pains that the user is experiencing. The relationship 715 carries over the data that the user has input during the first interactive digital design element 705, and the second interactive digital design element 710 may ask the user to position the pains identified based on the intensity and frequency of the pain.

FIG. 8 is a flowchart illustrating an example method 800 of handling the reception of input data from a user during a digital activity. The method 800 may be performed by any suitable system, apparatus, or device. For example, the method 800 may be performed by an electronic device of the user 120, the user 130, the users 140, and/or the user 150, and/or the server 110. The method 800 may represent operations associated with performing data storage associated with the user input (illustrated collectively as the blocks 810) and/or displaying data associated with the user input (illustrated collectively as the blocks 830). Although illustrated with discrete blocks, the steps and operations associated with one or more of the blocks of the method 800 may be divided into additional blocks, combined into fewer blocks, or eliminated, depending on the particular implementation.

At block 805, a user input is received while interacting with a digital activity. In some embodiments, any of a variety of inputs may be included. For example, the user input may include a freeform input, placement of an icon or other element in a plot space, selecting a position on a slider, or any other input. After the user input is received at the block 805, the storage 810 and display 830 of data related to the user input may be configured. In these and other embodiments, the storage 810 and display 830 of data related to the user input may be configured in any order and/or simultaneously. In some embodiments, storage of user input data may include the storage of user interactions with the digital activity via an electronic device such as keystrokes, the path of a cursor directed by a computer mouse or mousepad, or touches on a touch screen.

At block 815, when configuring the storage 810 of data related to the user input, a determination may be made whether or not the data is to be anonymized. For example, a setting or attribute of the digital activity set while creating the user activity may designate that the user data is to be anonymized. As another example, a default setting may include anonymizing data before storing the input data. If the user input data is to be anonymized, the method 800 may proceed to block 820. If the user input data is not to be anonymized, the method 800 may proceed to block 825.

At block 820, only the input of the user participating in the digital activity may be configured to be stored in an associated data structure. For example, when storing the user input any identifying information for the user such as a user ID, user name, employee identification number, email address, photograph of the user, digital avatar of the user, IP address, MAC address, and/or other identifying information and/or combinations thereof may be removed prior to storing the input of the user.

At block 825, the input of the user participating in the digital activity may be saved in the associated data structure in conjunction with identifying information of the user providing the input. For example, the user input may be saved in conjunction with their user ID, user name, employee identification number, email address, photograph of the user, digital avatar of the user, IP address, MAC address, and/or other identifying information and/or combinations thereof.

At block 835, when configuring the display 830 of data related to the user input, a determination may be made whether or not the user input data is to be made available to one or more users. For example, a setting or attribute of the digital activity set while creating the user activity may designate that the user data is to be made available or to be displayed. If the input data is to be made available, the method 800 may proceed to the block 840. If the input data is not to be made available, the method 800 may end.

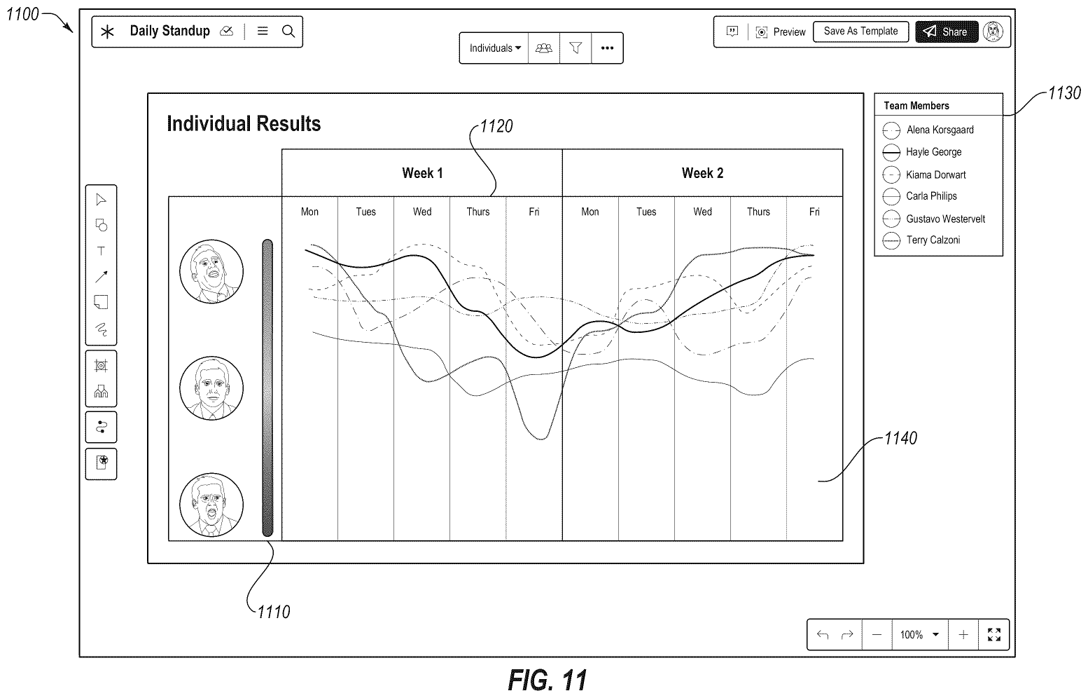

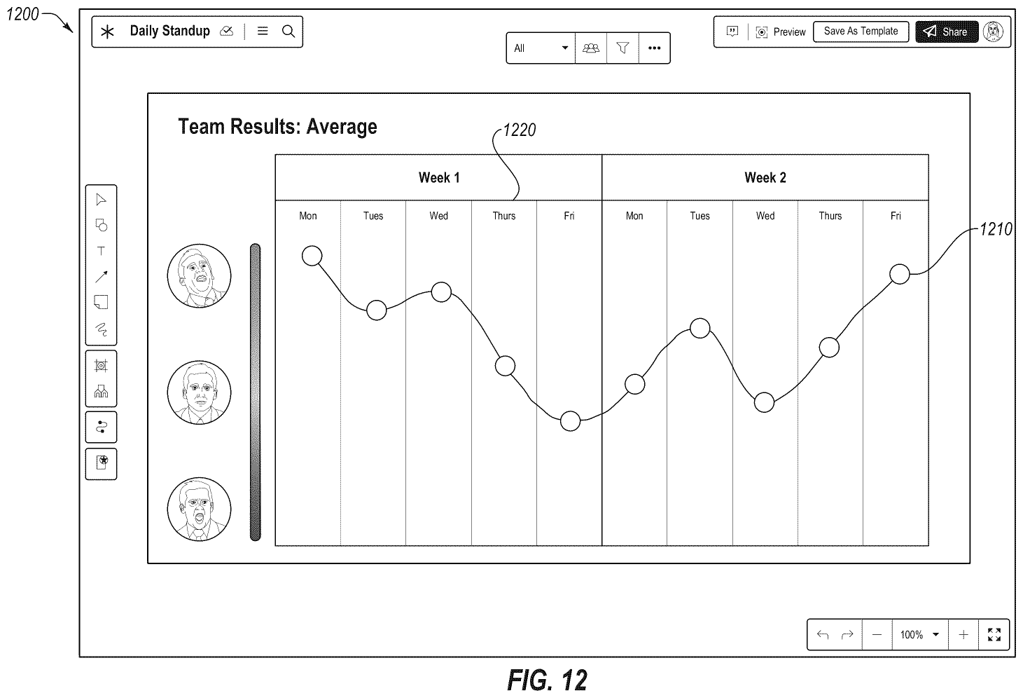

At block 840, the data associated with the user input may be configured to be displayed. For example, the data may be displayed to the user that participated in the digital activity. As another example, the data may be displayed to another user, may be posted to a website or posting board, or any other location. In these and other embodiments, the user input data or data related to the user input may be configured to display during or after the user participation in the digital activity. In these and other embodiments, the user input data or data related to the user input may be displayed in a visual space, such as the shared visual space in which multiple users are participating in a digital activity. Examples of displays of data related to user input may be described with reference to FIGS. 11 and 12.

Modifications, additions, or omissions may be made to the method 800 without departing from the scope of the disclosure. For example, another method of handling the reception of user input data during a digital activity may not include the display of data, or it may include additional determinations when storing data. Additionally, the designations of different operations in the manner described is meant to help explain concepts described herein and is not limiting. Further, the method 800 may include any number of other operations or may be implemented within other systems or contexts than those described.

FIG. 9 is a flowchart illustrating an example method 900 of processing input data from multiple users received during a digital activity. The method 900 may be performed by any suitable system, apparatus, or device. For example, the method 900 may be performed by an electronic device of the user 120, the user 130, the users 140, and/or the user 150, and/or the server 110. The method 900 may represent operations associated with performing data storage 910 associated with the user input and/or displaying data 930 associated with the user input. Although illustrated with discrete blocks, the steps and operations associated with one or more of the blocks of the method 900 may be divided into additional blocks, combined into fewer blocks, or eliminated, depending on the particular implementation.

At block 905, an initial user input may be received while a user is participating in a digital activity. The block 905 may be similar or comparable to the block 805.

At block 910, the initial user input may be stored in a data structure. For example, as user input is received during the deployment of the digital activity, the data structure may be generated automatically with the deployment of the digital activity and the user input may be stored in the associated data structure.

At block 915, an additional user input may be received, and a determination may be made whether the additional user input is received from a new user or from the same user as provided the initial user input at the block 905 but later in time. If the additional user input is from a new user, the method 900 may proceed to the block 920. If the input is received from the same user, the method 900 may proceed to the block 925.

At block 920, the new input may be stored in the data structure. The block 920 may be similar or comparable to the block 820 and/or the block 825

At block 925, the new input may be stored in the data structure along with a timestamp of when the additional input occurred. For example, the block 925 may be similar or comparable to the block 820 and/or the block 825, although in addition to the other storage aspects, a timestamp of when the additional input was received may also be stored. It will be appreciated that such a timestamp may be used in some or all circumstances and is not limited to circumstances in which the same user provides user input later in time during a digital activity.

At block 930, a determination may be made of whether there are additional user inputs. If there are additional user inputs, the method 900 may return to block 915. If there are no additional user inputs, the method 900 may proceed to block 935. In these and other embodiments, the method 900 may return from block 930 to block 915 any number of times. For example, the method 900 may cycle through that portion of the method 900 until there are no new additional user inputs.

At block 935, a determination may be made whether or not analytics are to be applied to one or more of the user inputs. If analytics are to be applied to the user inputs, the method 900 may proceed to block 940. If analytics are not to be applied to the user inputs, the method 900 may proceed to block 945.

At block 940, one or more analytics may be applied to one or more of the user inputs. For example, the user inputs may be aggregated (e.g., summed, averaged, or any other combination) over time for a given user during one instance of the digital activity. As another example, the user inputs of multiple users participating with a given digital activity may be aggregated. As an additional example, the user inputs of a single user across multiple different digital activities may be aggregated. As another example, the user inputs of multiple users across multiple different digital activities may be aggregated. As an additional example, multiple user inputs may be compared to each other (e.g., a difference generated; a mean, median, or mode determined; a variance computed; among others).

At block 945, a determination may be made whether or not the data structure includes time stamps associated with the stored user inputs. In some embodiments, the display of the user inputs may be configured differently depending on whether the data structure of stored user inputs contains time stamps. If the data structure contains time stamps, the method 900 may proceed to block 950. If the data structure does not contain time stamps, the method 900 may proceed to block 955.

At block 950, the user input data, including the accompanying time stamps marking the time at which the inputs were made, may be displayed to the users. In some embodiments, user inputs may include the selection of a button or option or a point on a plot with x- and y-coordinates. In some embodiments, the time stamps may be used to mark the different inputs for the same users over time. For example, a visual depiction of the user inputs may be presented at different locations based on the timestamps with distance between the locations determined based on the difference between timestamps. As another example, the display may include a series of points or elements displayed at regular intervals with associated labels corresponding to the timestamps. In these and other embodiments, if the user inputs for multiple users are displayed, the display may depict different inputs for each user over time using the timestamps.

At block 955, user input data may be displayed to one or more users. For example, the data may be combined or have analytics performed at the block 940 to aggregate the data for display. Additionally or alternatively, a combination of collected and stored data of user inputs may be displayed. In some embodiments, the displayed data may be presented graphically, textually, or in any other manner by which users may view and interpret the data.

In some embodiments, for both the block 950 and/or the block 955, the display of the user input data or data related to user inputs may occur during or after user participation in the digital activity. Some examples of such displays are illustrated and described with reference to FIGS. 11 and 12. FIG. 11 illustrates an example display 1100 showing individual results of multiple users over time, and FIG. 12 illustrates an example display 1200 showing averaged results of multiple users over time.

Modifications, additions, or omissions may be made to the method 900 without departing from the scope of the disclosure. For example, another method of handling the reception of user input data during a digital activity may include a limitation on the number of users who may generate inputs or a limitation on the number of times a single user may generate new inputs by repeating the digital activity. Additionally, the designations of different operations in the manner described is meant to help explain concepts described herein and is not limiting. Further, the method 900 may include any number of other operations or may be implemented within other systems or contexts than those described.

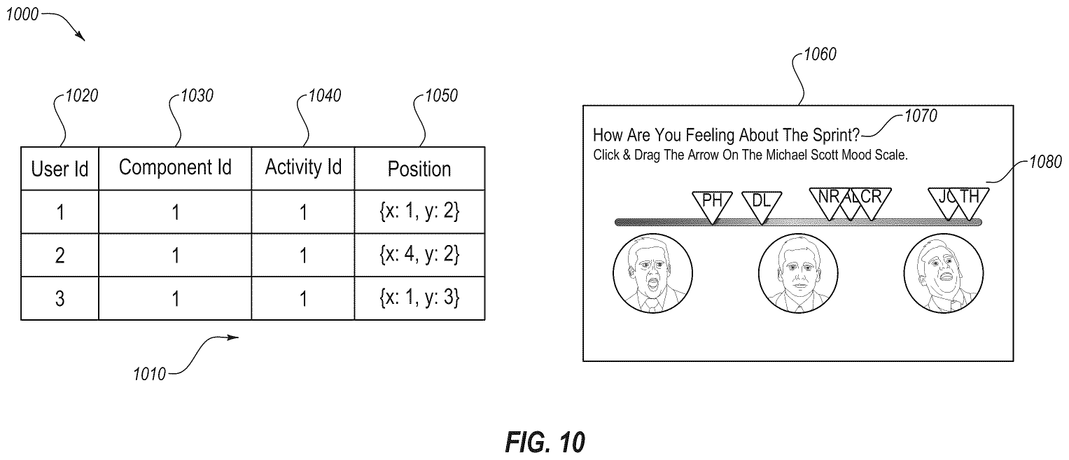

FIG. 10 illustrates an example visualization 1000 of a visual representation of stored user input data 1010 associated with performing a digital activity 1060. In some embodiments, the stored user input data 1010 may include identification of the users 1020 who performed the inputs, identification of the component 1030 of the digital activity 1060 which received the input, the identification of the digital activity 1040 which received the input, and/or the user input 1050 itself.

In the visualization 1000, the user input includes an x-coordinate indicating the location of the marker representing the selection made by the user along an axis 1080 which is displayed in the activity 1060. In this example, the results displayed in the activity 1060 shows the text of a question 1070 asked of the participating users and an axis 1080 along which participating users have placed tokens. As illustrated, the visualization 1000 may include a display of the inputs provided by multiple users and may include identification of the users and their answers to the question 1070 displayed in a visual form via which the user and their associated selection may be visually observed. In some embodiments, such as that illustrated in the visualization 1000, a user interacting with the digital activity 1060 may view their own selection and/or the selection of one or more other users. Such other users' selections may be displayed before the user makes their own selection or may be displayed after the user makes and/or confirms their selection.

In some embodiments, the data related to the user inputs may not be displayed during user participation with the digital activity. Alternatives may include storing the data related to user inputs for future display. Further, the data related to the user inputs may differ based on the task(s) and/or question(s) included in the digital activity.

FIG. 11 is an example digital display 1100 of data related to user inputs from multiple users across multiple interactions with an example digital activity over time. In the example display 1100, the user inputs include user-selected positions along an axis 1110, where multiple users 1130 generated inputs each day 1120 for two weeks. The aggregate user inputs (e.g., the combined and line-fitted user inputs) are plotted on the graph 1140.

In some embodiments, as the multiple users 1130 interact with the same digital activity each day over the two weeks, the user input data may be stored and/or have analytics performed on the data. When displaying the accumulation of the user inputs over the two weeks, a line-fitting curve may be applied to the various inputs. In some embodiments, such as the example illustrated in the display 1100, the various inputs for the multiple users 1130 may be overlaid on each other such that the comparative responses may be viewed in addition to a macro-level view across all of the multiple users 1130. For example, the display 1100 illustrates that over the first week, the overall responses generally declined over the course of the week while during the second week, the overall responses generally increased over the course of the week.

In some embodiments, the display of user inputs or data related to user inputs may be shown to the users upon completion of the digital activity, upon completion of one question or task in the digital activity, and/or some time after completion of the digital activity.

FIG. 12 is another example digital display 1200 of inputs from multiple users across multiple user interactions with a digital activity over time. The display 1200 may be similar or comparable to the display 1100 of FIG. 11 and may be based on the same received user inputs. However, the display 1200 may illustrate an average of the user inputs received over time, rather than the individual results displayed separately.

In some embodiments, the inputs from multiple users may be averaged and an average plot line 1210 may be generated for each point in time 1220 as a day the inputs are collected. In the display 1200, averaging the inputs of multiple users may serve to anonymize the data. Additionally or alternatively, other analytics may be performed on the user inputs or data related to user inputs before display, including finding the median, mode, standard deviation, range, variance, or best fit line and/or other statistical or non-statistical analyses.

In some embodiments, a user viewing the displays 1100 and/or 1200 may select from one or more display options for which they desire to observe the visualizations of the data. For example, the user may select to view individual results and be presented with the display 1100. Additionally or alternatively, the user may select to view averaged results for a set of users and may be presented with the display 1200.

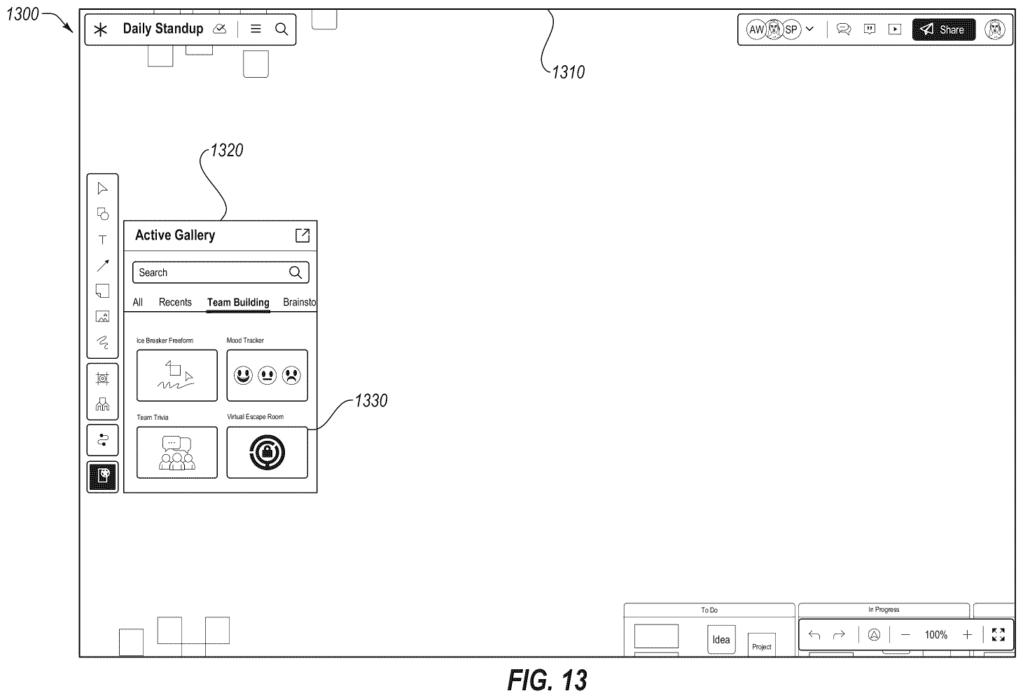

FIG. 13 is an example GUI 1300 through which a creator of an activity may utilize a template to generate the activity. In this and other embodiments, the construction of a digital activity make take place in a visual space 1310. An options panel or menu 1320 may be present in the visual space 1310 that contains one or more templates 1330. Templates 1330 may include partial or complete digital activities and/or partial or complete questions or tasks which may be included in a digital activity. In these and other embodiments, the templates 1330 may include multiple interactive digital design elements with attributes and/or relationships between the multiple interactive digital design elements. For example, a template 1330 may exist that is a complete digital activity designed to ask employees two successive questions about their well-being at the company. Another example may be a template 1330 for a task requiring users to draw their favorite food, which may utilize a relationship to insert the drawn favorite food into a new or existing digital activity. In some embodiments, templates 1330 may be created by a user to be utilized in the future. Additionally or alternatively, templates 1330 may already exist and may be available for a user to employ once the user gains access to the visual space.

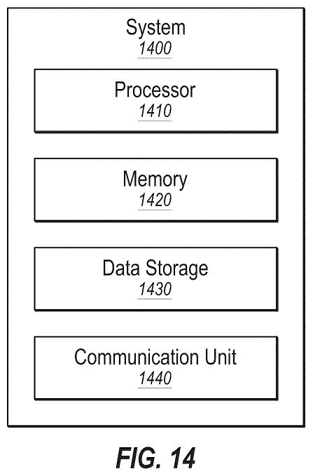

FIG. 14 illustrates an example computing system 1400, according to at least one embodiment described in the present disclosure. The computing system 1400 may include a processor 1410, a memory 1420, a data storage 1430, and/or a communication unit 1440, which all may be communicatively coupled. Any or all of the digital activity generating method 200 of FIG. 2 may be implemented as a computing system consistent with the computing system 1400.

Generally, the processor 1410 may include any suitable special-purpose or general-purpose computer, computing entity, or processing device including various computer hardware or software modules and may be configured to execute instructions stored on any applicable computer-readable storage media. For example, the processor 1410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 14, it is understood that the processor 1410 may include any number of processors distributed across any number of network or physical locations that are configured to perform individually or collectively any number of operations described in the present disclosure. In some embodiments, the processor 1410 may interpret and/or execute program instructions and/or process data stored in the memory 1420, the data storage 1430, or the memory 1420 and the data storage 1430. In some embodiments, the processor 1410 may fetch program instructions from the data storage 1430 and load the program instructions into the memory 1420.

After the program instructions are loaded into the memory 1420, the processor 1410 may execute the program instructions, such as instructions to perform operations associated with any of the methods 200, 600, 800, and/or 900 of FIGS. 2, 6, 8, and/or 9, respectively.

The memory 1420 and the data storage 1430 may include computer-readable storage media or one or more computer-readable storage mediums for having computer-executable instructions or data structures stored thereon. Such computer-readable storage media may be any available media that may be accessed by a general-purpose or special-purpose computer, such as the processor 1410. For example, the memory 1420 and/or the data storage 1430 may store user inputs or data related to user inputs obtained when the users participated in the digital activity one or more times. In some embodiments, the computing system 1400 may or may not include either of the memory 1420 and the data storage 1430.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1410 to perform a certain operation or group of operations.

The communication unit 1440 may include any component, device, system, or combination thereof that is configured to transmit or receive information over a network. In some embodiments, the communication unit 1440 may communicate with other devices at other locations, the same location, or even other components within the same system. For example, the communication unit 1440 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 1440 may permit data to be exchanged with a network and/or any other devices or systems described in the present disclosure. For example, the communication unit 1440 may allow the system 1400 to communicate with other systems, such as computing devices and/or other networks.

One skilled in the art, after reviewing this disclosure, may recognize that modifications, additions, or omissions may be made to the system 1400 without departing from the scope of the present disclosure. For example, the system 1400 may include more or fewer components than those explicitly illustrated and described.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present disclosure.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of creating a digital activity, comprising:
receiving input to select an interactive digital design element to be added to the digital activity, the interactive digital design element configured to allow multiple users to interact with the interactive digital design element when deploying the digital activity;
generating a data structure, the data structure representative of a repository into which user input data are stored when interacting with the interactive digital design element when deployed;
receiving input to designate one or more input modalities for the digital activity when deployed, the one or more input modalities including at least one of a virtual pen, a sticky note deploying tool, or a shape deploying tool; and
deploying the interactive digital design element in a visual space shared between the multiple users.

2. The method of claim 1, further comprising adding an attribute to the interactive digital design element prior to deploying the digital activity, the data structure formatted based on the attribute, wherein the interactive digital design element and the attribute include at least one of:
the interactive digital design element includes multiple lines and the attribute includes the multiple lines designated as a plot configured to receive first user input in an area of the plot;
the interactive digital design element includes a two-dimensional shape and the attribute includes the two-dimensional shape designated as a container configured to permit the placement of other interactive digital design elements within the container;
the interactive digital design element includes a two-dimensional shape and the attribute includes the two-dimensional shape designated as selectable such that a user is able to select the interactive digital design element when deployed;
the interactive digital design element includes a two-dimensional shape and the attribute includes the two-dimensional shape designated as moveable such that the user can move the interactive digital design element within the shared visual space when deployed; or
the interactive digital design element includes a two-dimensional area and the attribute includes the two-dimensional area configured to receive freeform user inputs.

3. The method of claim 1, further comprising adding an attribute to the interactive digital design element prior to deploying the digital activity, the data structure formatted based on the attribute, wherein the interactive digital design element and the attribute include at least one of:
the interactive digital design element includes multiple lines and the attribute includes the multiple lines designated as a plot configured to receive first user input in an area of the plot;
the interactive digital design element includes a line and the attribute includes the line designated as a slider configured to receive input to select a discrete location along the line;
the interactive digital design element includes a two-dimensional shape and the attribute includes the two-dimensional shape designated as a container configured to permit the placement of other interactive digital design elements within the container;
the interactive digital design element includes a two-dimensional shape and the attribute includes the two-dimensional shape designated as selectable such that a user is able to select the interactive digital design element when deployed;
the interactive digital design element includes a two-dimensional shape and the attribute includes the two-dimensional shape designated as moveable such that the user can move the interactive digital design element within the shared visual space when deployed; or
the interactive digital design element includes a two-dimensional area and the attribute includes the two-dimensional area configured to receive freeform user inputs.

4. The method of claim 1, wherein at least one of text or a graphic are nested within the interactive digital design element, the graphic from a graphic library including images, memes, and graphics interchange formats (GIFs), and animated GIFs.

5. The method of claim 1, wherein the data structure is configured to receive user inputs including singular data points, freeform inputs, or combinations thereof.

6. The method of claim 1, further comprising adding a second interactive digital design element to the digital activity.

7. The method of claim 6, further comprising configuring an interaction between the interactive digital design element and the second interactive digital design element, the interaction including transferring at least one user input data of the user input data from the interactive digital design element to the second interactive digital design element to be used by the second interactive digital design element.

8. The method of claim 7, wherein the interaction further includes transforming the at least one user input data from a first format to a second format prior to use in the second interactive digital design element.

9. The method of claim 7, further comprising displaying the at least one user input data in the interactive digital design element, and wherein the second interactive digital design element is configured to display the at least one user input data differently from the display of the at least one user input data in the interactive digital design element.

10. The method of claim 7, wherein the interaction is configured to prevent a user from viewing the second interactive digital design element until the user has provided input into the interactive digital design element.

11. The method of claim 7, wherein selecting the addition of the interactive digital design element includes also triggering the addition of the second interactive digital design element and the interaction between the interactive digital design element and the second interactive digital design element to the digital activity by a single user action.

12. The method of claim 7, wherein the interaction between the interactive digital design element and the second interactive digital design element is configured by a user who creates the digital activity by selecting menu options from a graphical user interface.

13. The method of claim 1, further comprising:
deploying the digital activity; and
receiving a first input from a first user interacting with the interactive digital design element and a second input from a second user interacting with the interactive digital design element,
wherein the first input and the second input are received either simultaneously or the first input is received before the second input.

14. The method of claim 13, further comprising, upon completion of receiving the first input and the second input, displaying a depiction of first data representative of the first input and second data representative of the second input.

15. The method of claim 14, wherein the depiction of the first data is not associated with the first user.

16. The method of claim 13, further comprising storing the first input to the data structure without association of the first input to the first user.

17. The method of claim 13, further comprising:
receiving a third input from the first user interacting with the interactive digital design element at a later point in time than the first input;
storing the first input and the third input as associated with the first user and with timestamps of respective times when the first input and the third input were received; and
displaying an aggregation of the first input and the third input.

18. The method of claim 13, further comprising, after receiving the first input and the second input:
displaying analytics of at least first data representative of the first input and second data representative of the second input, the analytics including at least one of: variance, average, median, mode, standard deviation, range, best-fit line.

19. A system comprising:
one or more processors; and
one or more non-transitory computer-readable storage media configured to store instructions that, in response to being executed, cause a system to perform operations, the operations comprising:
receiving input to select an interactive digital design element to be added to a digital activity, the interactive digital design element configured to allow multiple users to interact with the interactive digital design element when deploying the digital activity;
generating a data structure, the data structure representative of a repository into which user input data are stored when interacting with the interactive digital design element when deployed; and
deploying the interactive digital design element in a visual space shared between the multiple users, the interactive digital design element of the digital activity shareable in the visual space simultaneously by the multiple users.

20. One or more non-transitory computer-readable storage media configured to store instructions that, in response to being executed, cause a system to perform operations, the operations comprising:
receiving input to select an interactive digital design element to be added to a digital activity, the interactive digital design element configured to allow multiple users to interact with the interactive digital design element when deploying the digital activity;
generating a data structure, the data structure representative of a repository into which user input data are stored when interacting with the interactive digital design element when deployed, wherein the data structure is configured to receive user inputs including freeform drawing inputs created using a virtual pen; and
deploying the interactive digital design element in a visual space shared between the multiple users.
